(19) United States
(12) Patent Application Publication
(10) Pub. No.: US 2014/0054373 A1
(43) Pub. Date: Feb. 27, 2014

(54) FINANCIAL CERTIFICATION APPARATUS APPLIED WITH SMART DEVICE

(71) Applicant: Cheng-Tsung TSAI, New Taipei City (TW)

(72) Inventor: Cheng-Tsung TSAI, New Taipei City (TW)

(73) Assignee: SMARTCHIP MICROELECTRONIC CORP., New Taipei City (TW)

(21) Appl. No.: 13/593,522

(22) Filed: Aug. 24, 2012

(51) Int. Cl. G06K 5/00; G06K 7/01

(52) U.S. Cl. 235/380

(57) ABSTRACT

In a financial certification apparatus applied with a smart device, a certification device is mainly plugged into an audio plug hole of the smart device through an audio plug terminal, and a card reading interface reads financial certification information of a smart card, owned by the user. An audio conversion module converts the financial certification information into audio financial certification information. Finally, an application module generates a digital password according to the audio financial certification information so that the user completes the consumption behavior through the smart device.

### BACKGROUND OF THE INVENTION

(1) Field of the Invention

The invention relates to a financial certification apparatus applied with a smart device, and more particularly to a certification device applied with a smart device to perform financial consumption behaviors.

(2) Description of the Prior Art

At present, many transactions and financial transaction circulation ways have been developed from the exchanges of the simple money currency to various forms of plastic currencies, such as a credit card, a financial card, a cash card or the like. Because the plastic currency is light and thin and can be easily carried along, it is also possible to get rid of the trouble of carrying a lot of money currencies. Thus, the usage of the plastic currency is increasing year by year all over the world, and has become the consumption pattern selected by most of the people. Most of the patters using the plastic currency are to read the data of the plastic currency through a specific apparatus, after the data check passes, the action of the consumption payment can be completed. However, due to the popularization and the rapid development of the modern internet, many consumers perform the consumption behaviors over the internet through, for example, a smart mobile phone, a tablet computer, a notebook computer, a desktop computer or any other internet device. However, when the plastic currency is used for the consumption over the internet, the payment action has to be completed by inputting the card number, authentication code or password. The method of inputting the password by the user also induces many drawbacks and inconvenience, which are often criticized by the user.

Thus, it is an important subject of the invention to solve the above-mentioned drawbacks and problems.

### SUMMARY OF THE INVENTION

In view of the associated problems induced by the prior art, the present inventor has paid attention to the research and development according to the experience and the technology in manufacturing the associated products for many years, and thus developed this financial certification apparatus.

A main object of the invention is to plug a financial certification apparatus into an audio plug hole of a smart device mainly through an audio plug terminal, and to read the financial certification information of a smart card, owned by the user, through a card reading interface. An audio conversion module converts the financial certification information into audio financial certification information. Finally, an application module generates a digital password according to the audio financial certification information so that the user completes the consumption behavior through the smart device.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is a block diagram showing the architecture of the invention.

FIG. 2 is a block diagram showing a use state of the invention.

FIG. 3 is a schematic illustration showing another use state of the invention.

FIG. 4 is a schematic illustration showing still another use state of the invention.

FIG. 5 shows an advanced embodiment of the invention.

FIGS. 6 and 7 are block diagrams showing another embodiment of the invention.

### DETAILED DESCRIPTION OF THE PREFERRED EMBODIMENTS

The present invention will become more fully understood from the detailed description given hereinbelow and the accompanying drawings which are provided to achieve the above-identified effect, object and the adopted means, technique and structure.

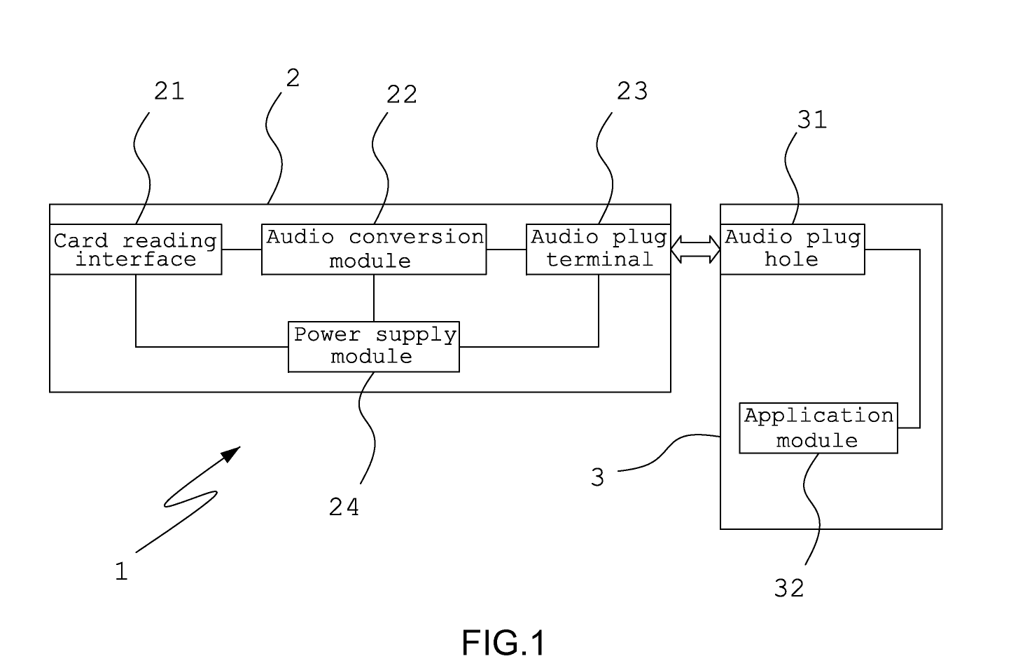

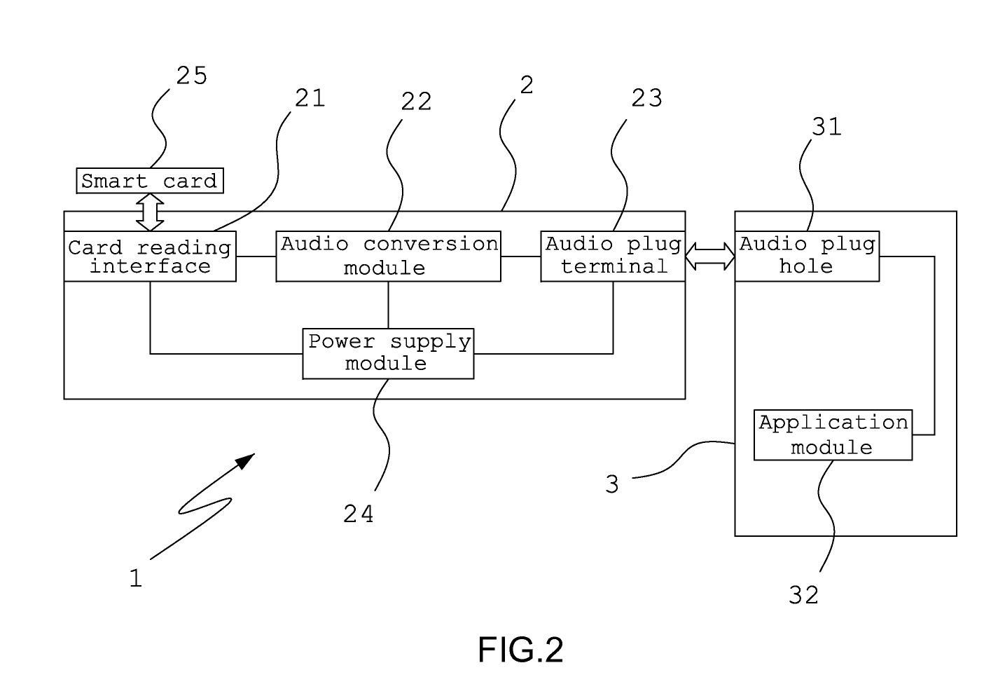

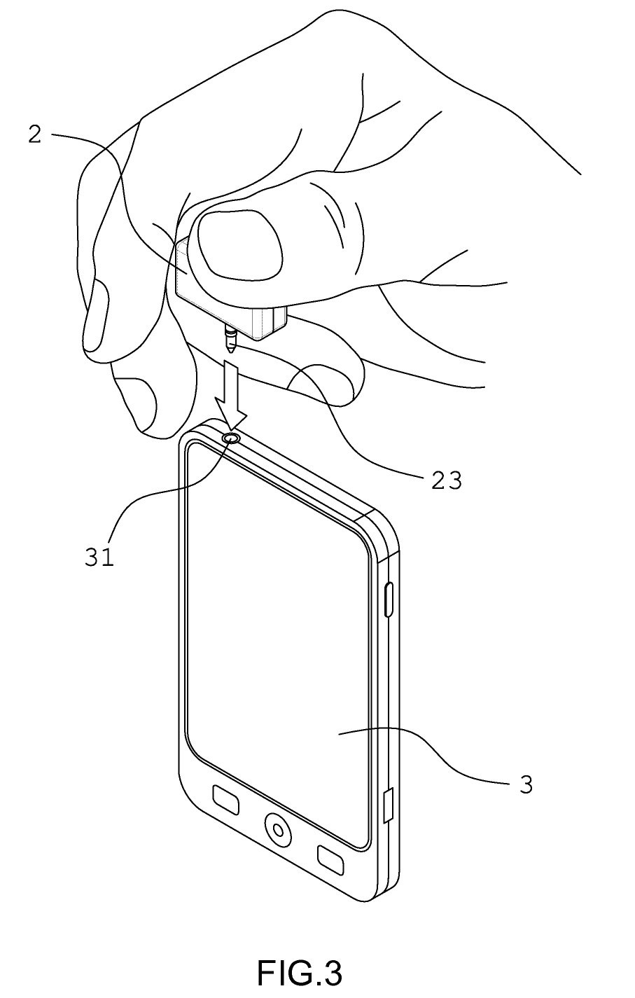

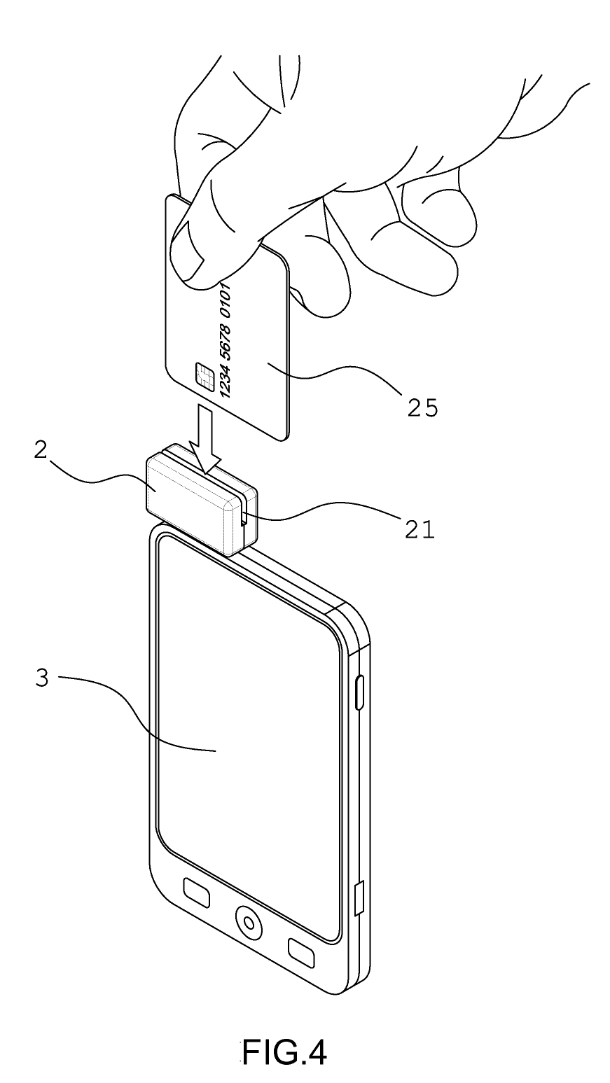

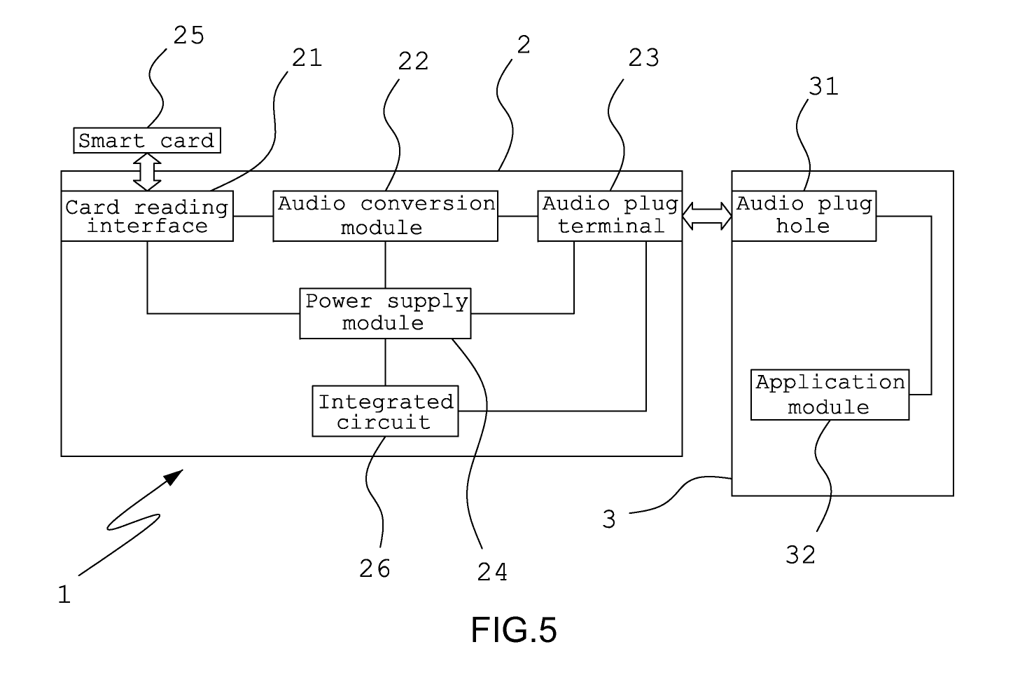

FIGS. 1 and 2 are block diagrams showing the architecture and a use state of the invention according to a preferred embodiment of the invention. FIGS. 3 and 4 are schematic illustrations showing another and still another use states of the invention. FIG. 5 shows an advanced embodiment of the invention. Referring to FIGS. 1 to 5, a financial certification apparatus 1 includes a certification device 2 and a smart device 3.

The certification device 2 includes a card reading interface 21, which is an interface with the IS07816-3 specification; an audio conversion module 22 electrically connected to the card reading interface 21; and an audio plug terminal 23 electrically connected to the audio conversion module 22.

In addition, the certification device 2 further includes a power supply module 24, which is electrically connected to the card reading interface 21 and the audio plug terminal 23, and supplies the required electric power.

The smart device 3 includes an audio plug hole 31, which is to be connected to the audio plug terminal 23 of the certification device 2; and an application module 32, which is electrically connected to the audio plug hole 31 and is the application software preloaded into the smart device 3.

When the user wants to perform the consumption behavior of purchasing goods over the internet through the smart device 3, such as a smart mobile phone, a tablet computer, a notebook computer, a desktop computer or any other device that can be connected to the internet, the user has to plug the certification device 2 into the audio plug hole 31 of the smart device 3 through the audio plug terminal 23, and place a smart card 25 (e.g., a conventional credit card, financial card or cash card), owned by the user, into the card reading interface 21. After the card reading interface 21 is enabled to read the financial certification information, such as the card number of the smart card 25, the identification code, the authentication code or the authorization code, the audio conversion module 22 converts the financial certification information into audio financial certification information, which is transferred to the smart device 3 through the audio plug terminal 23. Then, the application module 32 generates a digital password (card number, identification code, authentication code or authorization code) according to the audio financial certification information, and the digital password is finally directly inputted to the consumption system so that the object of completing the consumption behavior can be achieved.

The audio plug hole 31 is originally provided for the smart device 3 to connect to an external earphone, a speaker or other sound output devices and only can accept the audio signal. So, before the financial certification information is outputted to the smart device 3, the financial certification information still has to be converted into the audio financial certification information by the audio conversion module 22. Finally, the application module 32 generates the digital password according to the frequency, period, amplitude or phase of the audio financial certification information so as to provide the card number, the identification code, the authentication code or the authorization code to be inputted to the consumption system.

As mentioned hereinabove, after the audio plug terminal 23 is connected to the audio plug hole 31, a connection verification test is performed between the application module 32 and the certification device 2. That is, the smart device 3 outputs a detection signal from the audio plug hole 31 to the certification device 2. If the certification device 2 is truly connected to the smart device 3, then the certification device 2 also sends out a response signal to the smart device 3 through the audio plug hole 31. However, if the audio plug hole 31 has not received the response signal of the certification device 2, the smart device 3 again outputs a detection signal to the certification device 2 until the response signal of the certification device 2 is received. When the audio plug hole 31 receives the response signal (i.e., the connection verification test is completed), the application module 32 immediately outputs a signal to the certification device 2 to drive the certification device 2 to output the audio financial certification information.

The smart card 25 is a conventional credit card, financial card or cash card owned by the user. Because the contact interface of the smart card 25 has the IS07816-3 specification, the card reading interface 21 of the invention is an interface having the IS07816-3 specification so as to read the information from the smart card 25.

In addition, the certification device 2 may further have an integrated circuit 26 (see FIG. 5). The main technology is to store the data, which are equivalent to the card number, the identification code, the authentication code, the authorization code and/or the like contained in the smart card 25, into the integrated circuit 26 in advance in the bank or financial institution. However, the data are directly stored into the integrated circuit 26 in the form of the audio financial certification information. Thus, the information can be directly transferred to the smart device 3 without conversion being made by the audio conversion module 22. Of course, even if the certification device 2 itself has the integrated circuit 26, the user may also use the originally owned smart card 25 through the card reading interface 21 at the same time.

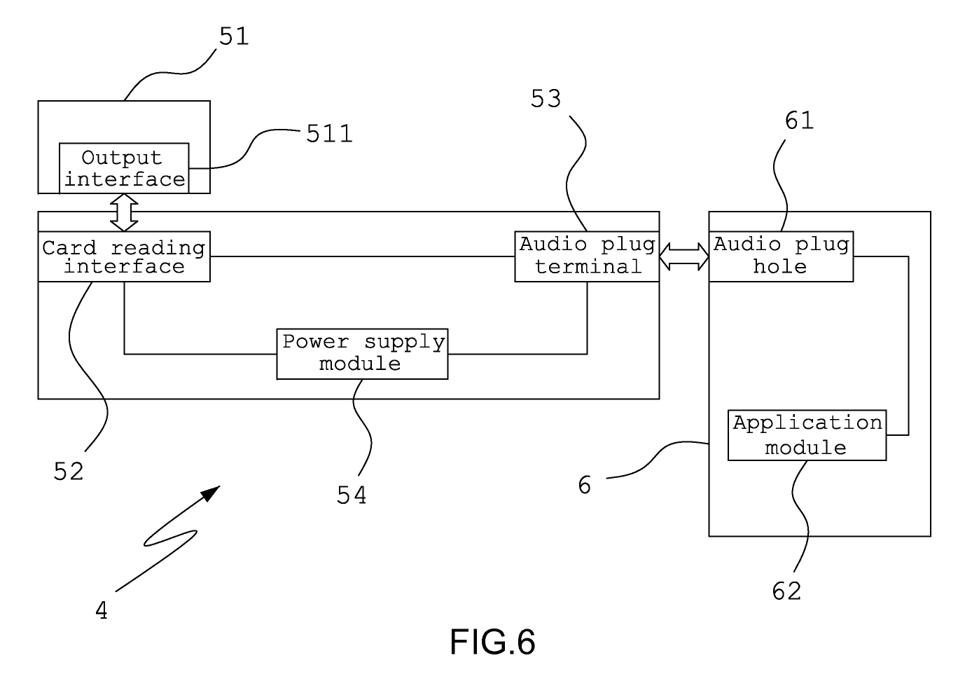

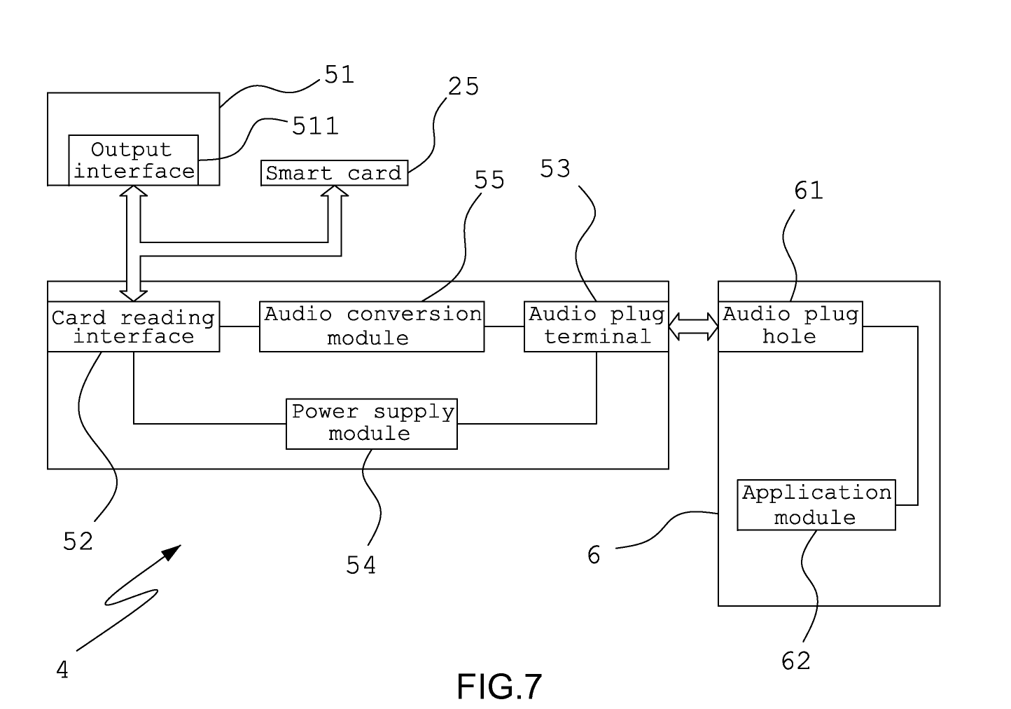

FIGS. 6 and 7 are block diagrams showing another embodiment of the invention. Referring to FIGS. 6 and 7, a financial certification apparatus 4 includes a certification device 5 and a smart device 6.

The certification device 5 includes a smart card 51, a card reading interface 52 and an audio plug terminal 53. The smart card 51 stores the financial certification information and has an output interface 511 disposed thereon. The output interface 511 has the interface for outputting audio and the interface with the IS07816-3 specification at the same time. The card reading interface 52 is for reading the smart card 51. The audio plug terminal 53 is electrically connected to the card reading interface 52.

In addition, the certification device 5 further has a power supply module 54, which is electrically connected to the card reading interface 52 and the audio plug terminal 53 and is for providing the required electric power.

The smart device 6 includes an audio plug hole 61 and an application module 62. The audio plug hole 61 is to be electrically connected to the audio plug terminal 53 of the certification device 5. The application module 62 is electrically connected to the audio plug hole 61, and may be the application software preloaded into the smart device 6.

The certification device 5 is plugged into the audio plug hole 61 of the smart device 6 (see FIG. 6) through the audio plug terminal 53, and the smart card 51 is placed into the card reading interface 52, so that the card reading interface 52 reads the financial certification information from the smart card 51, and the financial certification information is transferred to the smart device 6 through the audio plug terminal 53. Finally, the application module 62 generates a digital password (card number, identification code, authentication code or authorization code) according to the audio financial certification information, and the digital password is finally directly inputted to the consumption system so that the object of completing the consumption behavior can be achieved.

As mentioned hereinabove, the smart card 51 of this embodiment is not the conventional credit card, financial card or cash card owned by the user. This embodiment mainly stores the data, which are equivalent to the card number, the identification code, the authentication code, the authorization code and/or the like contained in the conventional smart card, into the smart card 51 directly in the form of the audio financial certification information in advance in the bank or financial institution. Thus, in this embodiment, the card reading interface 52 has the audio type interface, and the smart card 51 outputs the financial certification information through the output interface 511 with the IS07816-3 specification.

In order to let the user use the smart card 25, such as the conventional credit card, financial card or cash card owned by the user, at the same time, the certification device 5 may further have an audio conversion module 55 (see FIG. 7) for converting the financial certification information, read from the smart card 25, into the audio financial certification information. In addition, because the smart card 25, such as the conventional credit card, financial card or cash card owned by the user, has to be used, the card reading interface 52 of this embodiment must have the IS07816-3 interface specification, and the smart card 51 outputs the financial certification information through the output interface 511 with the IS07816-3 specification, so that the smart card 51 and the conventional smart card 25, such as the credit card, financial card or cash card, can be used in the certification device 5.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. A financial certification apparatus, comprising a certification device and a smart device, wherein:
the certification device comprises:
a card reading interface;
an audio conversion module electrically connected to the card reading interface; and
an audio plug terminal electrically connected to the audio conversion module; and
the smart device comprises:
an audio plug hole to be connected to the audio plug terminal of the certification device; and
an application module electrically connected to the audio plug hole, wherein:
the certification device is mainly plugged into the audio plug hole of the smart device through the audio plug terminal;
financial certification information in a smart card, owned by a user, is read by the card reading interface, and converted into audio financial certification information by the audio conversion module; and
the application module generates a digital password according to the audio financial certification information, so that the user completes a consumption behavior through the smart device.

2. The financial certification apparatus according to claim 1, wherein the card reading interface has an IS07816-3 specification.

3. The financial certification apparatus according to claim 1, wherein the certification device further comprises an integrated circuit storing the financial certification information.

4. The financial certification apparatus according to claim 1, wherein the smart card is a credit card, a financial card or a cash card owned by the user.

5. The financial certification apparatus according to claim 1, wherein the certification device further comprises a power supply module, which is electrically connected to the card reading interface, the audio conversion module and the audio plug terminal.

6. The financial certification apparatus according to claim 1, wherein the application module generates the digital password according to a frequency, a period, an amplitude or a phase of the audio financial certification information.

7. A financial certification apparatus, comprising a certification device and a smart device, wherein:
the certification device comprises:
a smart card storing financial certification information and having an output interface;
a card reading interface for reading the smart card; and
an audio plug terminal electrically connected to the card reading interface; and
the smart device comprises:
an audio plug hole to be connected to the audio plug terminal of the certification device; and
an application module electrically connected to the audio plug hole.

8. The financial certification apparatus according to claim 7, wherein the output interface and the card reading interface have interface specifications for outputting audio.

9. The financial certification apparatus according to claim 7, wherein the output interface and the card reading interface have IS07816-3 interface specifications.

10. The financial certification apparatus according to claim 7, wherein the certification device further has an audio conversion module.

11. The financial certification apparatus according to claim 10, wherein the certification device further has a power supply module electrically connected to the card reading interface, the audio conversion module and the audio plug terminal.
